(19) United States
(12) Patent Application Publication
(10) Pub. No.: US 2025/0162775 A1
(43) Pub. Date: May 22, 2025

(54) MOISTURE SCAVENGING FILM STRUCTURES

(71) Applicants: PROAMPAC HOLDINGS INC., Cincinnati, OH (US); CSP TECHNOLOGIES, INC., Auburn, AL (US)

(72) Inventors: Samuel J. Kessler, Cincinnati, OH (US); William F. Spano, Auburn, AL (US); Jedidiah L. Chubb, Roanoke, VA (US); Amir Saffar, Laval (CA); Seyed Hesamoddin Tabatabaei, Mason, OH (US)

(73) Assignees: PROAMPAC HOLDINGS INC., Cincinnati, OH (US); CSP TECHNOLOGIES, INC., Auburn, AL (US)

(21) Appl. No.: 18/952,042

(22) Filed: Nov. 19, 2024

Related U.S. Application Data
(60) Provisional application No. 63/600,921, filed on Nov. 20, 2023.

(51) Int. Cl. B65D 65/40; B01D 53/04; B01D 53/26; B01D 53/28; B32B 27/08; B32B 27/30; B32B 27/32; B65D 65/42

(52) U.S. Cl. CPC B65D 65/40; B01D 53/04; B01D 53/261; B01D 53/28; B32B 27/08; B32B 27/306; B32B 27/32; B65D 65/42; B01D 2253/202; B01D 2253/25; B01D 2253/304; B01D 2257/80; B32B 2307/7246; B32B 2307/7265; B65D 2565/381

(57) ABSTRACT

In one aspect, a moisture scavenging film comprises a moisture barrier layer and a sealant layer comprising an active co-continuous polymer material, the sealant layer disposed on the moisture barrier layer. In another aspect, a method for producing flexible packaging film including a moisture scavenging film includes providing a moisture barrier layer and providing a sealant layer comprising an active co-continuous polymer material. The sealant layer is applied onto the moisture barrier layer while maintaining a co-continuous morphology of the active co-continuous polymer material. In yet another aspect, a packaging article formed from a moisture scavenging film is provided.

### CROSS REFERENCE TO RELATED APPLICATION

This application claims the priority benefit of U.S. provisional application No. 63/600,921 filed Nov. 20, 2023. The aforementioned application is incorporated herein by reference in its entirety.

### BACKGROUND

The present disclosure relates to packaging in which it is desirable for the contents of the packaging to remain moisture-free. This issue is commonly addressed with desiccant sachets, often containing hydrophilic silica gel. The desiccant sachets are added to packages and absorb moisture from the air therewithin. Although typically non-toxic, desiccant sachets may present a choking hazard and are not recyclable. It is desirable, therefore, for the package itself to absorb the moisture from the air or other gas medium within the package.

The foregoing problem is addressed in one manner in the packaging films and methods disclosed in U.S. Patent Application Publication No. 2021/0122556, assigned to Wisepac USA Inc., of Marlton, NJ, and incorporated herein by reference in its entirety. The Abstract of the aforementioned publication suggests, “A high barrier packaging film has an outer layer of a high molecular polymer or a spunbond nonwoven fabric comprising a high molecular polymer, a passive barrier layer of the same high molecular polymer with nanoparticles of bentonite clay dispersed therein, an active barrier layer of the same high molecular polymer with desiccant particles dispersed therein, and a lamination layer of the same high molecular polymer. The outer layer, passive barrier layer and active barrier layer are compound laminated with the lamination layer to form the high barrier packaging film. Because the layers are all formed of a same polymer, such as polyethylene, and because there are no metal components in the layers used to create the film, the high barrier packaging film is readily recyclable.”

The problem is addressed in another manner in the films having a desiccant material incorporated therein and methods of use and manufacture disclosed in European Patent No. EP 2,004,400 B1, owned by Alcan Packaging Flexible, of Paris, France, and incorporated herein by reference in its entirety. EP 2,004,400 B1 states at paragraph 0001 that “Embodiments of the present invention relate to a film having a desiccant material incorporated therein. More specifically, embodiments of the present invention relate to a film structure having a desiccant material within a film layer of the film structure wherein the film structure is utilized in a package for a product that may be sensitive to the presence of moisture such as a drug coated medical stent or device. In addition, the embodiments of the present invention relate to methods of using the film having a desiccant material incorporated therein.”

The problem is addressed in another manner in the laminates and pouches whose sealants contain a chemical desiccant for active moisture scavenging and are sold under the trademarks AMCOR DESSIFLEX. These products are extrusion laminated structures with a base stock being bonded to a peelable desiccant sealant film. Without proper handling and storage of the rolls on which the laminate products are rolled, within 9 hours, 10% of capacity at 2.5 cm from the reel edge is lost, and within 48 hours, 10% of capacity at 7.6 cm from the reel edge is lost. The reels absorb approximately five times slower than the unwound open laminate.

The films in accordance with the present disclosure incorporate a moisture scavenging layer within a flexible packaging film structure in a different way. The present disclosure incorporates an adaptation of existing technology into a flexible film structure. The existing technology is three-phase active co-continuous polymer material of the type sold commercially by CSP Technologies, Inc., of Auburn, Alabama, under the trademark APTAR ACTIV-POLYMER. The three-phase active co-continuous polymer material may be as described in U.S. Pat. Nos. 5,911,937, 6,080,350, 6,124,006, 6,130,263, 6,194,079, 6,214,255, 6,486,231, 7,005,459, 9,902,788 and 11,141,978, each assigned to CSP Technologies, Inc., and each of which is hereby incorporated by reference in its entirety. The technology incorporates active chemistries to provide moisture control, gas scavenging (e.g., oxygen, carbon dioxide, ethylene, formaldehyde, nitrosamines, etc.), microbial pathogen reduction, and aroma reduction, or emission. The active co-continuous polymer material may be extruded into a film, injection molded, blow molded, or melted. The active co-continuous polymer material has been used successfully in a wide range of industrial applications. It may be provided as a continuous film or as die cut pieces. Some products are converted into injection molded parts. The active co-continuous polymer material may be applied by heat staking (a process by which dissimilar materials are joined together) or with adhesive. Articles produced with active co-continuous polymer materials have been disclosed with a thickness of 2 to 39 mil (0.05 to 1.0 mm) and are typically manufactured with a thickness of 11.8 to 472 mil (0.3 to 1.2 mm).

### SUMMARY

In one aspect, the present disclosure relates to a moisture scavenging films including a moisture barrier layer and a sealant layer. The sealant layer comprises an active co-continuous polymer material and is disposed on the moisture barrier layer. The active co-continuous polymer material comprises a primary phase formed of a primary phase polymer material forming a first continuous phase, a dispersed phase formed of an immiscible material forming a second continuous phase within the primary phase, and an active component comprising particles formed of one or more moisture absorbing and/or moisture adsorbing materials disposed within at least the dispersed phase.

In a more limited aspect, the moisture scavenging film further comprises an outer layer, wherein the moisture barrier layer is disposed between the outer layer and the sealant layer.

In another more limited aspect, the sealant layer is a coextrusion comprising an outside sealant layer, a middle sealant layer, and an inside sealant layer, wherein each of the outside sealant layer, middle sealant layer, and inside sealant layer, which may be the same or different, is formed of a composition comprising 0 to 100% by weight of the active co-continuous polymer material and 0 to 100% by weight of a diluent polymer composition, and further wherein the total weight of the active co-continuous polymer material in the sealant layer is in the range of 10% to 100% by weight based on the total weight of the sealant layer.

In another more limited aspect, the total weight of the active co-continuous polymer material in the sealant layer is in the range of 25% to 70% by weight based on the total weight of the sealant layer.

In another more limited aspect, the total weight of the active co-continuous polymer material in the sealant layer is in the range of 30% to 65% by weight based on the total weight of the sealant layer.

In another more limited aspect, the diluent polymer composition comprises one or more additives selected from the group consisting of polymer stabilizers, antiblocking agents, anti-slip agents, and processing aids.

In another more limited aspect, the diluent polymer composition comprises at least one polyolefin resin.

In another more limited aspect, the diluent polymer composition comprises at least one polyolefin resin selected from the group consisting of a polyethylene resin, an ethylene C₆-C₈ olefin copolymer resin, a metallocene-catalyzed polyethylene resin, a blown film resin, and any combination thereof.

In another more limited aspect, the sealant layer is a coextrusion comprising an outside sealant layer comprising one or more diluent polymer resins and optional additives, a middle sealant layer 0 to 100% by weight of the active co-continuous polymer material and 0 to 100% by weight of the one or more diluent polymer resins and optional additives, and an inside sealant layer comprising 10-100% by weight of the active co-continuous polymer material and 0-90% by weight of the one or more diluent polymer resins and optional additives. In another more limited aspect, the total weight of the active co-continuous polymer material in the sealant layer is in the range of 10% to 100% by weight based on the total weight of the sealant layer.

In another more limited aspect, the moisture scavenging film has a thickness in the range of 0.5 mil to 10 mil.

In another more limited aspect, wherein the moisture scavenging film has a thickness in the range of 1 mil to 6 mil.

In another more limited aspect, the sealant layer comprises one or more extrusion coating layers disposed on the moisture barrier layer.

In a further aspect, a packaging article is provided which is formed from the moisture scavenging film in accordance with the present disclosure.

In yet another aspect, a method for producing a flexible moisture scavenging packaging film includes providing a moisture barrier layer and providing a scalant layer comprising an active co-continuous polymer material. The sealant layer is applied onto the moisture barrier layer while maintaining a co-continuous morphology of the active co-continuous polymer material. The active co-continuous polymer material comprises a primary phase formed of a primary phase polymer material forming a first continuous phase, a dispersed phase formed of an immiscible material forming a second continuous phase within the primary phase, and an active component comprising particles formed of one or more moisture absorbing and/or moisture adsorbing materials disposed within at least the dispersed phase.

In another more limited aspect, the step of providing a sealant layer comprises extruding the sealant layer with an extruder and, during the extruding step, controlling one or more of an extrusion temperature, and extrusion speed, and an extrusion time to maintain the co-continuous morphology of the active co-continuous polymer material.

In another more limited aspect, the extruding step is a multilayer coextrusion process.

In another more limited aspect, applying the sealant layer to the moisture barrier layer comprises a lamination process selected from the group consisting of extrusion lamination, adhesive lamination, extrusion coating, and coextrusion coating.

In another more limited aspect, the method further includes rolling the flexible moisture scavenging packaging film onto a roll and packaging the roll within a moisture-resistant packaging material.

Exemplary materials from which the moisture barrier layer may be made include one or more of metalized film, foil, aluminum oxide, silicon oxide, polyethylene (PE), polypropylene (PP), and the like, as would be understood by persons skilled in the art. In embodiments, the moisture barrier layer is configured to provide a film having a moisture vapor transmission rate (MVTR) of 0 to 5 g/100 in²/day. Unless specified otherwise, all moisture vapor transmission rates herein are at 38° C. and 90% relative humidity (RH). In certain preferred embodiments, the MVTR is in the range of 0 to 0.5 g/100 in²/day. In certain preferred embodiments, the MVTR is in the range of 0 to 0.05 g/100 in²/day. The moisture barrier layer and sealant layer may be brought together by extrusion lamination or extrusion coating.

In embodiments, the sealant layer is formed of a composition comprising 10 to 100% by weight of an active co-continuous polymer material and 0 to 90% by weight of a diluent polymer resin and optional additives. In certain embodiments, the sealant layer is formed of a composition comprising 10%, 15%, 20%, 25%, 30%, 35%, 40%, 45%, 50%, 55%, 60%, 65%, 70%, 75%, 80%, 85%, 90%, 95%, or 100%, by weight, of an active co-continuous polymer material. In certain preferred embodiments, the sealant layer comprises 20-80% by weight of an active co-continuous polymer material and 20-80% by weight of a diluent polymer resin and optional additives. In certain preferred embodiments, the active co-continuous polymer material comprises 25-70% of an active co-continuous polymer material and 30-75% of diluent polymer resin with other additives. In certain preferred embodiments, the active co-continuous polymer material comprises 30-65% of an active co-continuous polymer material and 35-70% of diluent polymer resin with other additives. It will be understood by those skilled in the art that many different compositions of the sealant layer, including those with varying combinations and amounts of the active co-continuous polymer material, the one or more diluent polymer resins, and additives may be used in successfully forming the sealant layer.

As used herein, the term “active co-continuous polymer material” means a composite material having a co-continuous morphology comprising (a) a matrix or primary phase formed of a primary phase polymer material forming a first continuous phase or domain; (b) a dispersed phase formed of an immiscible material forming a second continuous phase or domain within the matrix; and (c) an active component comprising particles formed of one or more moisture absorbing and/or moisture adsorbing materials disposed within at least the dispersed phase.

In embodiments, the sealant layer is a monolayer. In alternative embodiments, the sealant layer has a multilayer, e.g., coextruded structure. The sealant layer may be applied to the moisture barrier layer by extrusion lamination, adhesive lamination, or as an extrusion coating, such as a blown extrusion coating, for example. The sealant layer has a sealant inside surface that faces the contents of the packaging when the moisture scavenging film is formed into a packaging article and a sealant outside surface that faces the moisture barrier layer. The sealant layer has heat sealability properties that allow it to bond and form a hermetic seal to another surface of the same material upon the application of heat and pressure.

In certain embodiments, the thickness of the sealant layer is 0.5 to 10 mil, e.g., 0.5 mil, 1 mil, 1.5 mil, 2 mil, 2.5 mil, 3 mil, 3.5 mil, 4 mil, 4.5 mil, 5 mil, 5.5 mil, 6 mil, 6.5 mil, 7 mil, 7.5 mil, 8 mil, 8.5 mil, 9 mil, 9.5 mil, 10 mil, or within any subrange therein. In certain embodiments, the thickness of the sealant layer is in the range of 1 to 6 mil. In certain embodiments, the thickness of the sealant layer is in the range of 1.25 to 5 mil.

In embodiments, the moisture scavenging film also includes an outer layer, such that the moisture barrier layer is disposed between the outer layer and the sealant layer. Exemplary materials from which the outer layer may be made include paper, polyethylene terephthalate (PET), cellophane, polyamide (PA), ethylene polymers and copolymers, propylene polymers and copolymers, and the like, as would be understood by persons skilled in the art. For the avoidance of doubt, this outer layer is a separate structure from the outside sealant layer discussed below with reference to multilayer polyolefin-based structures.

In certain embodiments, the sealant layer is a multilayer polyolefin-based structure formed, for example, by coextrusion or alternatively, by a series of extrusion coating or other coating steps. In certain embodiments, the sealant layer is a multilayer polyolefin-based structure including three or more coextruded layers. In embodiments, the sealant layer a three-layer, polyolefin-based structure including inside, middle, and outside sealant layers, where the inside sealant layer is disposed interiorly to face toward the contents of the packaging and the outside sealant layer is disposed exteriorly to face toward the moisture barrier layer. In embodiments having a multilayer sealant layer, at least the inside sealant layer comprises an active co-continuous polymer material and optionally one or more diluent polymer resin resins blended with the active co-continuous polymer material. Other additives, such as polymer stabilizers, antiblocking agents, anti-slip agents, and processing aids may also be included.

In a multi, e.g., three, layer sealant layer structure, the sealant layer sublayers comprise the active co-continuous polymer material; optionally, one or more diluent polymer resins; and, optionally, one or more blown film resins. It will be understood by those skilled in the art that many different compositions or configurations of the sealant layer, including those with varying combinations and amounts of the active co-continuous polymer material, the one or more diluent polymer resins, and the blown film resins may be used in these three-layer sealant layer structures. The sublayers of a multilayer sealant layer structure may include one or more extrusion coating layers. As used herein, the term “blown film resin” means a polymer resin that is compatible with blown film extrusion processes. Characteristics of such resins include one or more of (a) the ability to melt and flow smoothly during extrusion; (b) high melt strength; and (c) high bubble stability, which characteristics are advantageous for the production of high quality blown films. As used herein, the term “extrusion coating resin” refers to a polymer resin specifically formulated for compatibility with extrusion coating processes. Characteristics of such resins include one or more of the following: (a) the capability to smoothly melt and flow during the extrusion coating procedure; (b) strong adhesion properties to substrates; and (c) the ability to form a consistent and uniform coating, which characteristics are advantageous for achieving high-quality extrusion-coated materials.

In embodiments, the diluent polymer resins are olefin polymers or olefin copolymers. The sealant layer optionally further comprises one or more additives. In embodiments, the additives include polymer stabilizers, antiblocking agent, anti-slip agents, processing aids, and others.

The middle sealant layer comprises at least one of: the active co-continuous polymer material; one or more diluent polymer resins as described above; and/or one or more blown film resins as described above. The middle sealant layer optionally further comprises one or more additives as described above. The outside sealant layer comprises at least one of: the active co-continuous polymer material; one or more diluent polymer resins as described above; and/or one or more blown film resins as described above. The outside sealant layer optionally further comprises one or more additives as described above.

Although the above polyolefin-based coextrusion sealant layer is described as having three layers, a person skilled in the art will understand that the coextrusion may include five, seven, or more layers, which may include one or more barrier layers such as ethylene-vinyl alcohol copolymer (EVOH).

It will be understood by those skilled in the art that the diluent polymer resins may be any of a wide range of polyolefin resins, such as, polyethylene polymers and copolymers, polypropylene polymers and copolymers, including, without limitation, blown film resins and extrusion coating resins. Exemplary diluent polymer resins include metallocene catalyzed polyethylenes (mPE). In certain embodiments, the mPE is a metallocene ethylene C₆-C₈ olefin copolymer resin. In embodiments, the mPE is a metallocene linear low-density polyethylene (mLLDPE). An exemplary diluent polymer resin is an ethylene 1-hexene copolymer. In embodiments, the diluent polymer resin comprises one or more polyolefin resins commercially available under the EXXONMOBIL EXCEED trademark. Preferred diluent polymer resins provide a suitable balance of film performance and good mixing/distribution with the active co-continuous polymer material. It will be understood by those skilled in the art that the diluent polymer resins, having similar chemical characteristics, are largely interchangeable and, indeed, may be the same within a single film.

Other exemplary diluent polymer resins include polyolefin, e.g., polyethylene, resins, such as low density polyethylene (LDPE) resins. Exemplary diluent polymer resins are those compatible with blown film extrusion processes, especially those exhibiting a high melt strength and high bubble stability. Such diluent polymer resins can be selected, and optionally blended with other diluent polymer resins, to enhance bubble stability in a blown film process and otherwise create a strong and stable film bubble with a flat and even surface without creases, wrinkles, and undulations which can lead to, for example, scaling and lamination defects in a formed packaging article. Such diluent polymer resins are preferred to maintain stability and film flatness, particularly in embodiments where the active co-continuous polymer material is loaded in the range of 5-15%. Still other exemplary diluent resins include extrusion coating resins specifically formulated for or otherwise suitable for use in extrusion coating processes.

In embodiments, the primary phase polymer of the active co-continuous polymer material is a polymer having similar characteristics to the diluent polymer resins. The primary phase polymer is advantageously a polyolefin such as an LLDPE polyethylene, and preferably an LLDPE copolymer including ethylene comonomer and a hexene or octene comonomer. In embodiments, the primary phase polymer has a density sufficient to maintain toughness and scalability for converting needs and a melt flow index sufficient to maintain melt strength at high letdown percentages and to mix/distribute well with the one or more diluent polymer resins.

In certain embodiments, an antiblocking agent is provided to reduce frictional forces between film layers in contact. Exemplary antiblocking agents include silica, nepheline syenite, and others. Optionally, processing aids such as slip agents or the like, may be included, e.g., to reduce friction, enhance the polymer's melt flow, and facilitate smoother processing during film production.

In embodiments, the inside sealant layer contains between 10 and 100% by weight of the active co-continuous polymer material and between 0 and 90% by weight of one or more diluent polymer resins and optional additives. In certain preferred embodiments, the inside sealant layer contains between 40 and 55% by weight of the active co-continuous polymer material and between 45 and 60% by weight of one or more diluent polymer resins and optional additives.

In embodiments, the middle sealant layer contains between 0 and 100% by weight of the active co-continuous polymer material and between 0 and 100% by weight of one or more diluent polymer resins and optional additives.

In embodiments, the outside sealant layer contains no active co-continuous polymer material and contains only one or more diluent polymer resins as described above and optionally one or more additives, such as an antiblocking agent, polymer stabilizer, anti-slip agent, and/or processing aid.

In certain aspects, the present disclosure relates to a method for making a moisture scavenging film. In its most basic form, the method includes the steps of providing a moisture barrier layer; providing a sealant layer, where the sealant layer comprises up to 100% active co-continuous polymer material; and applying the sealant layer to the moisture barrier layer, where the application can be performed, for example, via extrusion or adhesive lamination or by applying the sealant layer as extrusion coating to the moisture barrier layer. Especially when the applying step is performed by extrusion lamination or extrusion coating, the applying step is performed with process parameters, including temperature, rotations per minute (RPM), and time such that the co-continuous morphology of the active co-continuous polymer material is maintained. The co-continuous morphology is the non-equilibrium, unstable morphology that is generated during the combination of the matrix, dispersed, and active particle phases into the active co-continuous polymer material. The output of the method of the present development is a thin, flexible film, no thicker than 10 mil, capable of scavenging moisture from its surroundings.

In embodiments where the sealant layer is a 100% active co-continuous polymer material monolayer, the step of providing a sealant layer comprises forming an active co-continuous polymer material film monolayer. Preferably, the active co-continuous polymer material film monolayer is formed by blown film extrusion, although other film forming processes can also be used, including extrusion coating.

In embodiments where the sealant layer includes less than 100% active co-continuous polymer material, the step of providing a sealant layer comprises combining the active co-continuous polymer materials and other components in an extruder to form a feed mixture and performing a single layer extrusion process to form the sealant layer. Again, process parameters, including extrusion temperature, RPM, and time should be such that the co-continuous morphology of the active co-continuous polymer material is maintained in the feed mixture and the resultant sealant layer.

In embodiments where the sealant layer is a multilayer coextruded film, the step of providing a sealant layer may comprise performing a coextrusion process. In embodiments, an extruder is provided for each layer. The components of each layer are combined in the respective extruder to produce respective feed mixtures. The feed mixtures are brought together using feed blocks and manifolds before they enter a coextrusion die which forms the multilayer configuration. In embodiments where the sealant layer has inside, middle, and outside sealant layers that have different compositions, three extruders would be utilized. For any layer that comprises the active co-continuous polymer material, the extrusion process parameters, including extrusion temperature, RPM, and time should be such that the co-continuous morphology of the active co-continuous polymer material is maintained in the corresponding feed mixture and the resultant layer of the sealant layer. The melting ranges and molecular weights of all components of the coextrusion process are all carefully considered factors in the coextrusion process. As discussed below, both the coextrusion process to form the sealant layer and the applying of the sealant layer onto the moisture barrier layer call for carefully controlled processing conditions.

As discussed above, processing aids may be used in the coextrusion process, particularly in the inside and outside layers of the coextruded sealant layer. The use of a processing aid in any layers containing or directly neighboring layers containing active co-continuous polymer material allows for improved flatness of melt at layer interfaces and on outer surfaces of the film. The application of the sealant layer onto the moisture barrier layer involves managing several process variables, including temperature, RPM, and time. The application process used will affect the overall tensile elongation and modulus of the flexible packaging film, both of which factors should remain within acceptable limits for the film's intended applications. How the applying is achieved will also affect the rate at which the sealant layer is capable of absorbing or adsorbing moisture and its moisture absorption/adsorption capacity. The relatively low temperatures maintain the integrity of the co-continuous morphology of the active co-continuous polymer material. Process variables should be controlled during the applying step so as to maintain the integrity of the co-continuous morphology, and consequently the efficacy of the sealant layer. Harsh processing, such as with higher temperatures and higher RPM may diminish the integrity of the morphology and therefore the efficacy of the moisture absorption/adsorption capacity of sealant layer.

In embodiments, the method also includes the step of heat sealing the film. This step may avoid delamination that may occur between the outer layer (when included) and the moisture barrier layer. The heat sealing step may be preferably performed on a sealing machine at between 75 and 150° C. with 0.5 second dwell time on a two side heated seal bar, with pressure of approximately 40 PSI. In certain embodiments, the heat sealing step is performed between 9° and 120° C. (0.5 second dwell and 40 PSI).

In embodiments, the method also includes the steps of rolling the thin film output of the method and packaging the rolls. It is preferred that film roll handling and packaging occur as soon after the extrusion process as possible, in order to mitigate efficacy deterioration. Moisture scavenging packaging articles formed of the moisture scavenging films in accordance with this disclosure are also provided. Methods of the manufacture of packaging articles and methods for scavenging moisture from an interior of a packaging article are also provided.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIGS. 1 and 2 are diagrams illustrating the layers of first and second exemplary embodiments of the moisture scavenging film, respectively.

FIG. 3 is a diagram of a coextruded sealant layer of the moisture scavenging film.

FIG. 4 is a flow chart illustrating the steps of an exemplary method for producing a moisture scavenging film.

FIGS. 5A and 5B are graphs showing moisture content against time of the surroundings of a moisture scavenging film in environments with different constant relative humidities.

FIGS. 6A and 6B are graphs showing relative humidity against time of the surroundings of a moisture scavenging film in environments with different initial relative humidities.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present development. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected.

As used in this application, the terms “front,” “rear,” “upper,” “lower,” “upwardly,” “downwardly,” “left,” “right,” and other orientation descriptors are intended to facilitate the description of the exemplary embodiment(s) of the present invention, and are not intended to limit the structure thereof to any particular position or orientation.

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5).

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein. When compositional percentage ranges are provided herein, it is to be understood that the combined percentages of all components within a specific composition will not exceed 100%. Unless otherwise specified, all percentages referenced herein are by weight.

The development is described herein primarily by way of reference to the removal of moisture from “air” with a packaging article for brevity and ease of description and references to air is expressly not intended to preclude the use of other gas compositions within the packaging. Various gases, including those used in Modified Atmosphere Packaging (MAP) and other gaseous environments, may be employed within the enclosed space, depending on the specific application and desired properties. The choice of gas composition within the packaging interior may be adapted to meet the particular requirements of the packaging, without departing from the broader scope of the disclosed technology.

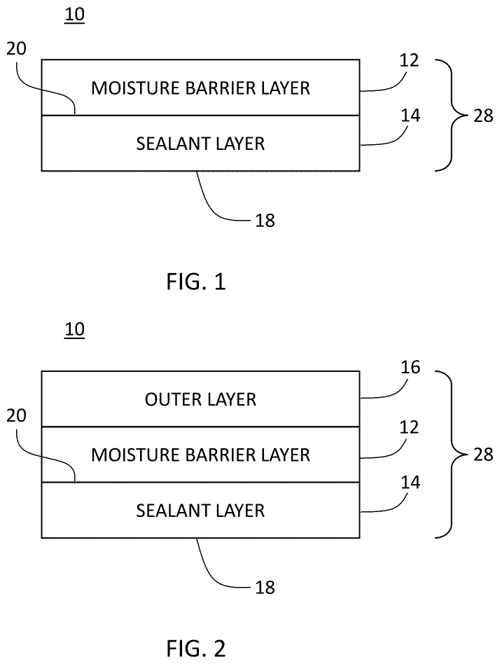

Referring now to the drawings, FIGS. 1 and 2 are diagrams illustrating the layers of an exemplary moisture scavenging film 10. The moisture scavenging film 10 includes moisture barrier layer 12 and sealant layer 14. The moisture barrier layer 12 is made of materials such as metalized film, foil, aluminum oxide, silicon oxide, PE, PP, and the like, as would be understood by persons skilled in the art. In embodiments, the moisture barrier is configured to provide a film having a moisture vapor transmission rate (MVTR) in the range of 0 to 5 g/100 in²/day. In embodiments, the MVTR is in the range of 0 to 0.5 g/100 in²/day. In certain embodiments, the MVTR is in the range of 0 to 0.05 g/100 in²/day. The moisture barrier layer 12 and sealant layer 14 may be brought together by extrusion lamination or extrusion coating.

In embodiments, the sealant layer 14 is formed of a composition comprising (a) 10 to 100% of an active co-continuous polymer material; and (b) 0 to 90% by weight of a diluent polymer resin and optional additives. In certain preferred embodiments, the diluent polymer resin comprises 20-80% active co-continuous polymer material and 20-80% diluent polymer resin and optional additives. In certain preferred embodiments, the active co-continuous polymer material comprises 30-70% diluent polymer resin and 30-70% diluent polymer resin with other additives. It will be understood by those skilled in the art that many different compositions of the sealant layer 14, including those with varying combinations and amounts of the active co-continuous polymer material, the one or more diluent polymer resins, and additives may be used in successfully forming the sealant layer 14.

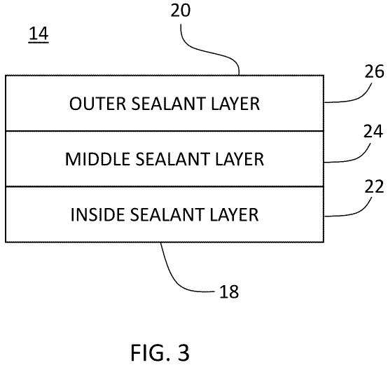

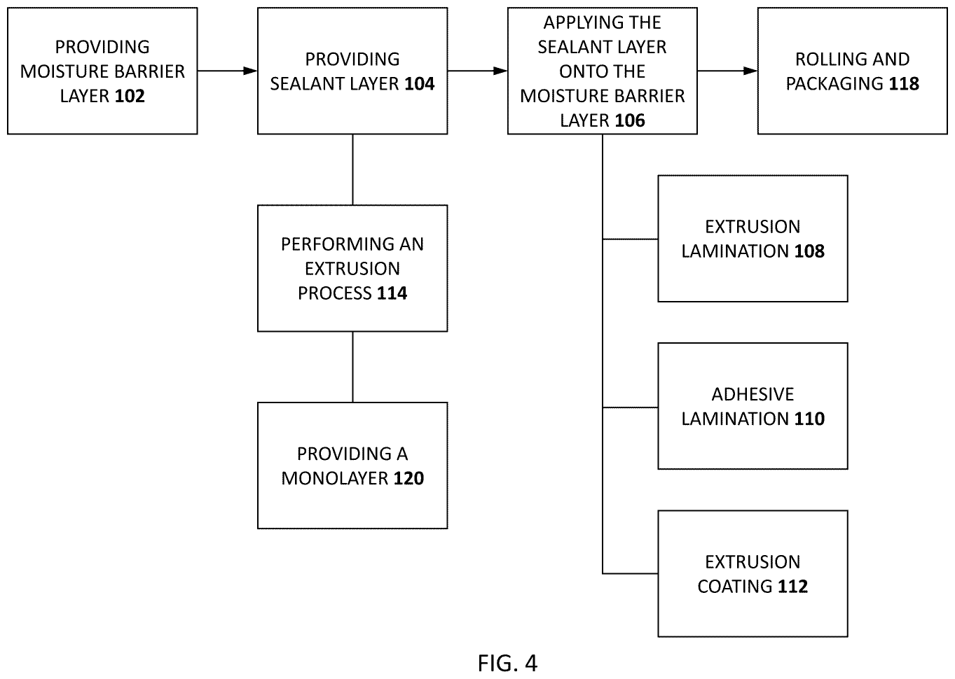

In certain embodiments, the sealant layer 14 is a monolayer. In alternative embodiments, the sealant layer has a multilayer, e.g., coextruded structure, as described for example, with reference to FIG. 3. The sealant layer 14 may be applied to the moisture barrier layer 12 by an extrusion lamination process, an adhesive lamination process, or as an extrusion coating. The sealant layer 14 has a sealant inside surface 18 that faces the contents of the packaging when the moisture scavenging film is formed into a packaging article, and a sealant outside surface 20 that faces the moisture barrier layer 12. The sealant layer has heat seal properties that allow it to bond and form a hermetic seal to another surface of the same material upon the application of heat and pressure.

In embodiments, the moisture scavenging film 10 has a thickness 28 of 0.5 to 10 mil, e.g., 0.5 mil, 1 mil, 1.5 mil, 2 mil, 2.5 mil, 3 mil, 3.5 mil, 4 mil, 4.5 mil, 5 mil, 5.5 mil, 6 mil, 6.5 mil, 7 mil, 7.5 mil, 8 mil, 8.5 mil, 9 mil, 9.5 mil, 10 mil, or within any subrange therein. In certain embodiments, the thickness of the sealant layer is in the range of 1 to 6 mil. In certain embodiments, the thickness of the sealant layer is in the range of 1.25 to 5 mil.

The embodiment of moisture scavenging film 10 shown in FIG. 2 additionally includes an optional outer layer 16, such that the moisture barrier layer 12 is disposed between the outer layer 16 and the sealant layer 14. The outer layer 16 is made of, for example, PET, PA, ethylene polymers and copolymers, cellophane, propylene polymers and copolymers, paper and the like, as would be understood by persons skilled in the art.

The three phases of the active co-continuous polymer material are a matrix or primary phase comprising a primary phase polymer, a dispersed phase comprising a channeling agent, and an active particulate phase, wherein the primary phase and the dispersed phase have a co-continuous morphology. The primary phase polymer provides structure for the material. The active particle is chosen for its desired characteristics, which may be application dependent. The desired characteristics may, for example, relate to the active particle's ability to absorb or adsorb moisture. The channeling agent forming the dispersed phase is an immiscible polymer or other material (as compared to the matrix polymer) that creates channels within the matrix polymer, allowing movement of gases. In embodiments, the channeling agent has a chemical attraction for the active particle, so that the active particle is drawn through or into the channels. Gas diffusion is controlled through the channel composition. The present development incorporates a much thinner version of the active co-continuous polymer material than has been previously manufactured and used in prior art applications.

As discussed above, active co-continuous polymer material has been used for applications other than flexible films. The thickness of the active co-continuous polymer material in such applications has typically been between 11.8 and 47.2 mil. While effective for certain applications, this prior art active co-continuous polymer material is relatively inflexible, in part due to its thickness and not suitable for forming flexible packaging films. The resultant moisture scavenging film 10 is a versatile product with many applications, such as flexible packaging film, which were not previously contemplated for active co-continuous polymer material products.

Now referring to FIG. 3, there is shown a multilayer embodiment of the sealant layer 14, which may be formed by coextrusion or alternatively, by a series of extrusion coating or other coating steps. The sealant layer 14 includes inside, middle, and outside sealant layers 22, 24, 26, respectively, where the sealant inside surface 18 is disposed on the sealant inside layer 22 so as to face toward or contact the contents of the packaging and the sealant outside surface 20 is disposed on the exterior facing side of the sealant outside layer 26 to facing toward the moisture barrier layer 12, as shown in FIGS. 1 and 2).

Each of the inside, middle, and outside sealant layers 22, 24, 26 may include one or more of diluent polymer resins, blown film or extrusion coating resins, and the active co-continuous polymer material One or more optional additives, such as antiblocking agents, anti-slip agents, polymer stabilizers, and processing aids may also be included. Although the polyolefin-based coextrusion sealant layer 14 is described as having three layers, a person skilled in the art will understand that the coextrusion may include five, seven, or more layers, which may include one or more barrier layers such as EVOH. In preferred embodiments, the total weight of the active co-continuous polymer material in the sealant layer 14 is in the range of 10% to 100% by weight based on the total weight of the sealant layer 14.

It will be understood by those skilled in the art that the diluent polymer resins may be any of a wide range of polyolefin resins, such as, polyethylene polymers and copolymers, polypropylene polymers and copolymers, including, without limitation, blown film resins and extrusion coating resins. Exemplary diluent polymer resins include metallocene catalyzed polyethylenes (mPE). In certain embodiments, the mPE is a metallocene ethylene C₆-C₈ olefin copolymer resin. In embodiments, the mPE is a metallocene linear low-density polyethylene (mLLDPE). An exemplary diluent polymer resin is an ethylene 1-hexene copolymer. In embodiments, the diluent polymer resin may be one or more polyolefin resins commercially available under the EXXONMOBIL EXCEED trademark. Preferred diluent polymer resins provide a suitable balance of film performance and good mixing/distribution with the active co-continuous polymer material. It will be understood by those skilled in the art that the diluent polymer resins, having similar chemical characteristics, are largely interchangeable and, indeed, may be the same within a single film.

Other exemplary diluent polymer resins include polyolefin, e.g., polyethylene, resins, such as low density polyethylene (LDPE) resins. Exemplary diluent polymer resins are those compatible with blown film extrusion processes, especially those exhibiting a high melt strength and high bubble stability. Such diluent polymer resins can be selected, and optionally blended with other diluent polymer resins, to enhance bubble stability in a blown film process and otherwise create a strong and stable film bubble with a flat and even surface without creases, wrinkles, and undulations which can lead to, for example, sealing and lamination defects in a formed packaging article. Such diluent polymer resins are preferred to maintain stability and film flatness, particularly in embodiments where the active co-continuous polymer material is loaded in the range of 5-15%. Still other exemplary diluent resins include extrusion coating resins specifically formulated for or otherwise suitable for use in extrusion coating processes.

In embodiments, the primary phase polymer of the active co-continuous polymer material is a polymer having similar characteristics to the diluent polymer resins. The primary phase polymer is advantageously a polyolefin such as an LLDPE polyethylene, and preferably an LLDPE copolymer including ethylene comonomer and a hexene or octene comonomer. In embodiments, the primary phase polymer has a density sufficient to maintain toughness and scalability for converting needs and a melt flow index sufficient to maintain melt strength at high letdown percentages and to mix/distribute well with the one or more diluent polymer resins.

Optionally, an antiblocking agent may be provided to reduce frictional forces between film layers in contact. Exemplary antiblocking agents include silica, nepheline syenite, and others. Optionally, processing aids such as slip agents or the like, may be included, e.g., to reduce friction, enhance the polymer's melt flow, and facilitate smoother processing during film production.

Now referring to FIG. 4, the steps of the method 100 for producing a moisture scavenging film are provided. Method 100 includes the steps of providing a moisture barrier layer 102; providing a sealant layer 104; and applying the sealant layer to the moisture barrier layer 106, where the applying may be achieved, for example, by extrusion 108 or adhesive lamination 110 or by applying the sealant layer as extrusion coating 112 to the moisture barrier layer. The output of the method 100 of the present disclosure is a thin, flexible packaging film, no thicker than 10 mil, capable of scavenging moisture from its surroundings. The method 100 may also include the step rolling and packaging the resultant flexible packaging film 118.

In embodiments where the sealant layer is a 100% active co-continuous polymer material monolayer, the step of providing a sealant layer 104 comprises forming an active co-continuous polymer material film monolayer 120. Preferably, the active co-continuous polymer material film monolayer is formed by blown film extrusion, although other film forming processes can also be used, including extrusion coating. During the extrusion process 120, process parameters, including temperature. RPM, and time, are controlled such that the co-continuous morphology of the active co-continuous polymer material is maintained in the feed mixture and ultimately in the sealant layer.

In embodiments where the sealant layer includes less than 100% active co-continuous polymer material, the step of providing a sealant layer 104 comprises admixing the active co-continuous polymer material with the other ingredients, e.g., as a feed mixture in an extrusion process 114. During the extrusion process 114, process parameters, including temperature, RPM, and time, are controlled such that the co-continuous morphology of the active co-continuous polymer material is maintained in the feed mixture and ultimately in the sealant layer.

In certain embodiments wherein the sealant layer is a monolayer, the extrusion process can be performed with a single extruder. In embodiments wherein the sealant layer is a multilayer coextruded structure, the coextrusion process may utilize separate extruders (or separate channels in a multichannel extruder) for distinct layers or compositions. However, it is recognized that a single extruder (or a single channel of a multichannel extruder) can simultaneously produce multiple layers of like composition, thereby facilitating the formation of complex multilayer structures. The components of each layer or composition are combined in the respective extruder to produce respective feed mixtures. The feed mixtures are brought together using feed blocks and manifolds before they enter a coextrusion die which forms the multilayer configuration.

For any layer that comprises the active co-continuous polymer material, the extrusion process parameters, including extrusion temperature, RPM, and time should be controlled such that the co-continuous morphology of the active co-continuous polymer material is maintained in the corresponding feed mixture and the resultant layer of the sealant layer. As discussed below, both the coextrusion process to form the sealant layer and the applying of the sealant layer onto the moisture barrier layer call for carefully controlled processing conditions.

As discussed above, processing aids may be used in the coextrusion process, particularly in the inside and outside layers of the coextruded sealant layer. The use of a processing aid in any layers containing or directly neighboring layers containing active co-continuous polymer material allows for improved flatness of melt at layer interfaces and on outer surfaces of the film.

Applying the sealant layer to the moisture barrier layer at step 106 involves controlling several process variables, including temperature, RPM, and time. How the applying is achieved will affect the overall tensile elongation and modulus of the flexible packaging film, both of which factors should remain within acceptable limits for the film's intended applications. How the applying is achieved will also affect the rate at which the sealant layer is capable of absorbing or adsorbing moisture and its moisture absorption/adsorption capacity. The relatively low temperatures maintain the integrity of the co-continuous morphology of the active co-continuous polymer material. A suitable combination of process variables should be maintained during the applying step so as to maintain the integrity of the co-continuous morphology, and consequently the efficacy of the sealant layer. Harsh processing, such as with higher temperatures and higher RPM may diminish the integrity of the morphology and therefore the efficacy of the sealant layer.

Method 100 may also include the steps of rolling the thin film output of the method onto a roll and packaging the rolls 118. The packaging step 118 should utilize moisture resistant and air-tight materials or containers to protect the moisture scavenging film from moisture exposure during storage to maintain its moisture-scavenging capacity before use. Since the sealant layer of moisture scavenging film will absorb or scavenge moisture from the surroundings, the packaging step will advantageously increase the shelf life of the film and maintain efficacy until the film is ready to be converted into packaging articles.

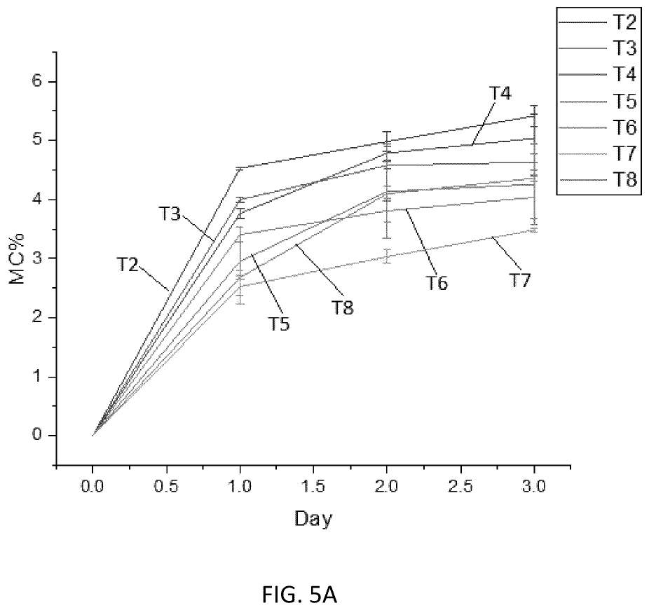

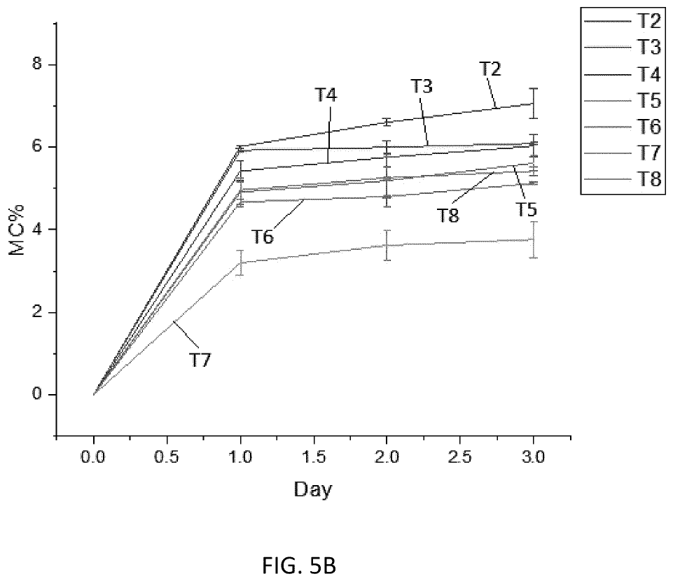

Now referring to FIGS. 5A and 5B, graphs illustrating test results of moisture content percentage versus time (in days) at constant relative humidities are provided. These graphs illustrate the results of tests of how much moisture can be scavenged by a moisture scavenging film. The moisture scavenging film was exposed to an environment with a constant relative humidity, i.e., as the moisture scavenging film scavenged the environment's moisture, moisture was added to the environment to maintain a constant relative humidity. The weight of the moisture scavenging film was monitored over time, the percent weight gain of the moisture scavenging film indicating the percent moisture content scavenged by the moisture scavenging film. The results shown in FIG. 5A indicate measurements made at a constant relative humidity of 25%. The results shown in FIG. 5B indicate measurements made at a constant relative humidity of 97%. The percentage of moisture content scavenged by the moisture scavenging film is dependent on the relative humidity. The lower (25%) relative humidity environment indicated in FIG. 5A resulted in a lower moisture content percentage. The higher (97%) relative humidity environment indicated in FIG. 5B resulted in a higher moisture content percentage.

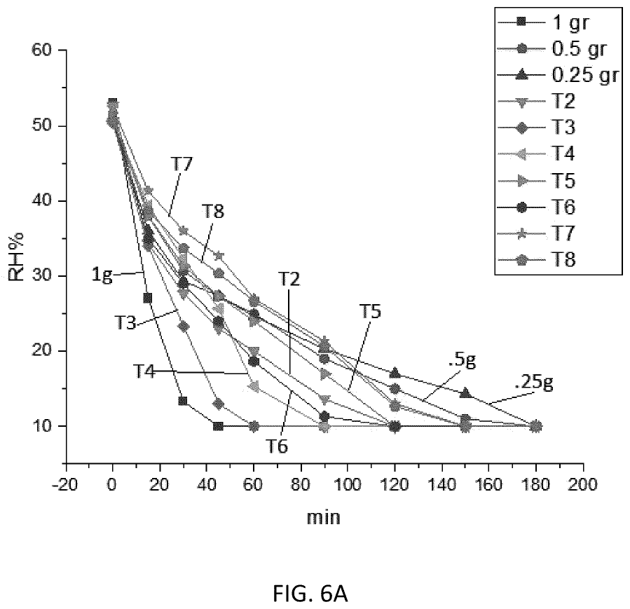

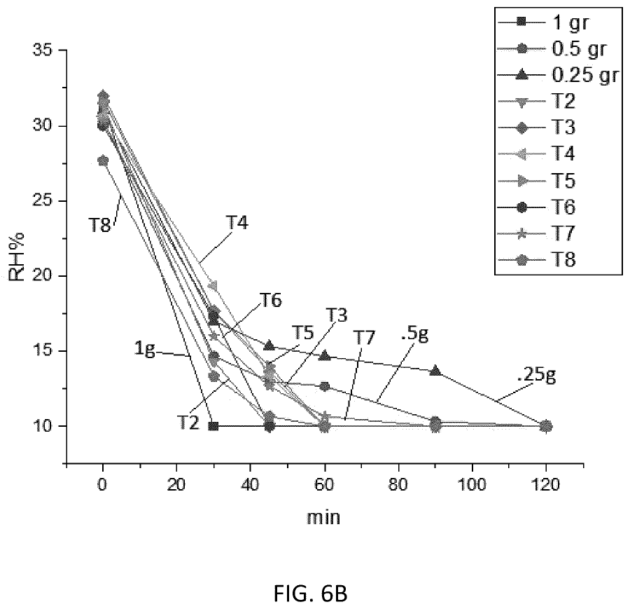

Now referring to FIGS. 6A and 6B, graphs illustrating test results of relative humidity versus time (in minutes) are provided. Each test begins with a moisture scavenging film in an airtight vessel at a specific relative humidity. The relative humidity within the vessel is measured over time, as the moisture scavenging film scavenges the moisture from within the vessel. The starting relative humidity of the tests shown in FIG. 6A is 54%. The starting relative humidity of the tests shown in FIG. 6B is 33%. In addition to testing the moisture scavenging film in these conditions, 1 g, 0.5 g, and 0.25 g desiccant sachets were also tested. The moisture scavenging film was shown to perform at least as well as the 0.5 g desiccant sachet and generally better than the 0.25 g desiccant sachet.

In each of FIGS. 5A-6B, each test, T2 through T8, was performed using different formulations of the moisture scavenging film. Variations in the moisture scavenging film formulation may be required for different applications. A particular moisture scavenging film formulation may be customized for use in colder temperatures, for example. Different coextrusion formulations may be employed. A sealant layer may be anti-slip, for example, by making the middle layer 100% active co-continuous polymer material and having no active co-continuous polymer material in either of the sealant inside or outside layers. Different thicknesses of the moisture scavenging film may be required for different scenarios.

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. A moisture scavenging film comprising:
a moisture barrier layer; and
a sealant layer comprising an active co-continuous polymer material, the sealant layer disposed on the moisture barrier layer, wherein the active co-continuous polymer material comprises:
a primary phase formed of a primary phase polymer material forming a first continuous phase;
a dispersed phase formed of an immiscible material forming a second continuous phase within the primary phase; and
an active component comprising particles formed of one or more moisture absorbing and/or moisture adsorbing materials disposed within at least the dispersed phase.

2. The moisture scavenging film of claim 1, further comprising an outer layer, wherein the moisture barrier layer is disposed between the outer layer and the sealant layer.

3. The moisture scavenging film of claim 1, wherein the sealant layer is a coextrusion comprising:
an outside sealant layer;
a middle sealant layer; and
an inside sealant layer;
wherein each of the outside sealant layer, middle sealant layer, and inside sealant layer, which may be the same or different, is formed of a composition comprising 0 to 100% by weight of the active co-continuous polymer material and 0 to 100% by weight of a diluent polymer composition, and further wherein the total weight of the active co-continuous polymer material in the sealant layer is in the range of 10% to 100% by weight based on the total weight of the sealant layer.

4. The moisture scavenging film of claim 3, wherein the total weight of the active co-continuous polymer material in the sealant layer is in the range of 25% to 70% by weight based on the total weight of the sealant layer.

5. The moisture scavenging film of claim 3, wherein the total weight of the active co-continuous polymer material in the sealant layer is in the range of 30% to 65% by weight based on the total weight of the sealant layer.

6. The moisture scavenging film of claim 3, wherein the diluent polymer composition comprises one or more additives selected from the group consisting of polymer stabilizers, antiblocking agents, anti-slip agents, and processing aids.

7. The moisture scavenging film of claim 3, wherein the diluent polymer composition comprises at least one polyolefin resin.

8. The moisture scavenging film of claim 7, wherein the diluent polymer composition comprises at least one polyolefin resin selected from the group consisting of a polyethylene resin, an ethylene C₆-C₈ olefin copolymer resin, a metallocene-catalyzed polyethylene resin, a blown film resin, and any combination thereof.

9. The moisture scavenging film of claim 1, wherein the sealant layer is a coextrusion comprising:
an outside sealant layer comprising one or more diluent polymer resins and one or more optional additives;
a middle sealant layer 0 to 100% by weight of the active co-continuous polymer material and 0 to 100% by weight of the one or more diluent polymer resins and one or more optional additives; and
an inside sealant layer comprising 10-100% by weight of the active co-continuous polymer material and 0-90% by weight of the one or more diluent polymer resins and one or more optional additives.

10. The moisture scavenging film of claim 9, wherein, the total weight of the active co-continuous polymer material in the sealant layer is in the range of 10% to 100% by weight based on the total weight of the sealant layer.

11. The moisture scavenging film of claim 1, wherein the moisture scavenging film has a thickness in the range of 0.5 mil to 10 mil.

12. The moisture scavenging film of claim 11, wherein the moisture scavenging film has a thickness in the range of 1 mil to 6 mil.

13. The moisture scavenging film of claim 1, wherein the sealant layer comprises one or more extrusion coating layers disposed on the moisture barrier layer.

14. A packaging article formed from the moisture scavenging film of claim 1.

15. A method for producing a flexible moisture scavenging packaging film, the method comprising:
providing a moisture barrier layer;
providing a sealant layer comprising an active co-continuous polymer material; and
applying the sealant layer onto the moisture barrier layer while maintaining a co-continuous morphology of the active co-continuous polymer material;
wherein the active co-continuous polymer material comprises:
a primary phase formed of a primary phase polymer material forming a first continuous phase;
a dispersed phase formed of an immiscible material forming a second continuous phase within the primary phase; and
an active component comprising particles formed of one or more moisture absorbing and/or moisture adsorbing materials disposed within at least the dispersed phase.

16. The method of claim 15, wherein providing a sealant layer comprises:
extruding the sealant layer with an extruder; and
during the extruding, controlling one or more of an extrusion temperature, an extrusion speed, and an extrusion time to maintain the co-continuous morphology of the active co-continuous polymer material.

17. The method of claim 16, wherein extruding the sealant layer comprises a multilayer coextrusion process.

18. The method of claim 15, wherein applying the sealant layer to the moisture barrier layer comprises a lamination process selected from the group consisting of extrusion lamination, adhesive lamination, extrusion coating, and coextrusion coating.

19. The method of claim 15, further comprising rolling the flexible moisture scavenging packaging film onto a roll and packaging the roll within a moisture-resistant packaging material.
